(19) United States
(12) Patent Application Publication
(10) Pub. No.: US 2014/0177239 A1
(43) Pub. Date: Jun. 26, 2014

(54) FLASHLIGHT HOLDER WITH LANYARD

(71) Applicant: Stanley Middleton Wyatt, III, Monroe, LA (US)

(72) Inventor: Stanley Middleton Wyatt, III, Monroe, LA (US)

(21) Appl. No.: 13/726,514

(22) Filed: Dec. 24, 2012

(51) Int. Cl. F21V 19/00

(52) U.S. Cl. CPC F21V 19/00
USPC 362/382

(57) ABSTRACT

A flashlight holder maintains a mounted flashlight's light beam projection in the general sight line for both walking and/or doing a project that requires the use of both hands. The flashlight holder includes a base having a holding cylinder with an axis angled from the base such that when the flashlight is inserted in the holding cylinder, the flashlight is angled relative to the user's body to provide a light projection in front of the user. The base can be attached to an adjustable lanyard for the user to wear around their neck. One of more adjustment screws can be provided to secure the flashlight in the holding cylinder.

### BACKGROUND OF THE INVENTION

The present invention relates to flashlight accessories and, more particularly, to a flashlight holder with lanyard that allows a user to use both hands while still maintaining use and direction of a flashlight.

Conventional flashlights require one hand of the user to control and direct the light in a desired orientation. To free up a user's hands, some conventional lights are worn on the user's head. These lights work to keep the user's hands free, but are generally integrated units that cannot use a user's own flashlight. Other lights can attach to a user's pocket, like an ink pen. With these lights, the direction of the light can be difficult to control and, like the headband lights, these lights are integrated units that do not allow the user to use their own flashlight.

As can be seen, there is a need for an improved flashlight holder with lanyard that allows a user to use their own flashlight and place/mount it to free their hands.

### SUMMARY OF THE INVENTION

In one aspect of the present invention, a flashlight holder comprises a holding cylinder; a base supporting the holding cylinder, wherein the holding cylinder is angled at an angle from about 30 to about 50 degrees from the base; an adjustable lanyard extending from the base; and a securing mechanism for securing a flashlight inside the holding cylinder.

In another aspect of the present invention, a flashlight holder comprises a holding cylinder; a base supporting the holding cylinder, wherein the holding cylinder is angled at an angle from about 30 to about 50 degrees from the base; an adjustable lanyard extending from the base; one or more threaded bosses extending into an interior of the holding cylinder; threaded inserts disposed in the one or more threaded bosses; a securing mechanism for securing a flashlight inside the holding cylinder; and a flexible composite material piece disposed on a portion of an inside surface of the holding cylinder, wherein the securing mechanism threads into the one or more threaded bosses to secure the flashlight inside the holding cylinder.

These and other features, aspects and advantages of the present invention will become better understood with reference to the following drawings, description and claims.

### BRIEF DESCRIPTION OF THE DRAWINGS

FIG. 1 is a perspective view of a flashlight holder, in use, according to an exemplary embodiment of the present invention;

FIG. 2 is a perspective view of the flashlight holder of FIG. 1 showing the flashlight removed by removing the adjustment screws;

FIG. 3 is a side view of the flashlight holder of FIG. 1, with the flashlight installed; and

FIG. 4 is a cross-sectional view taken along line 4-4 of FIG. 3.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a flashlight holder that maintains a mounted flashlight's light beam projection in the general sight line for both walking and/or doing a project that requires the use of both hands. The flashlight holder includes a base having a holding cylinder with an axis angled from the base such that when the flashlight is inserted in the holding cylinder, the flashlight is angled relative to the user's body to provide a light projection in front of the user. The base can be attached to an adjustable lanyard for the user to wear around their neck. One of more adjustment screws can be provided to secure the flashlight in the holding cylinder.

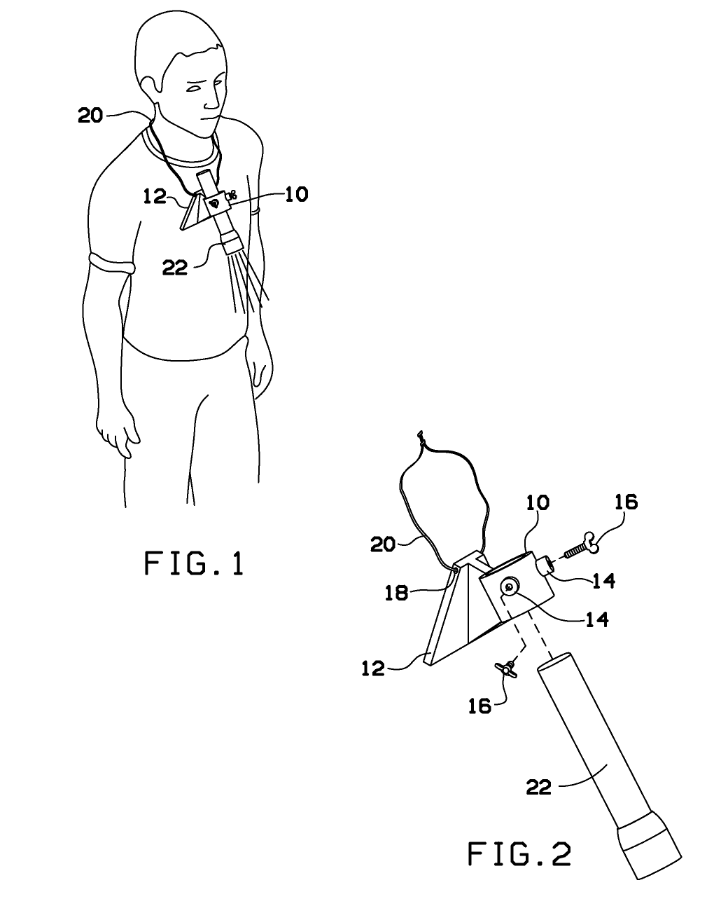

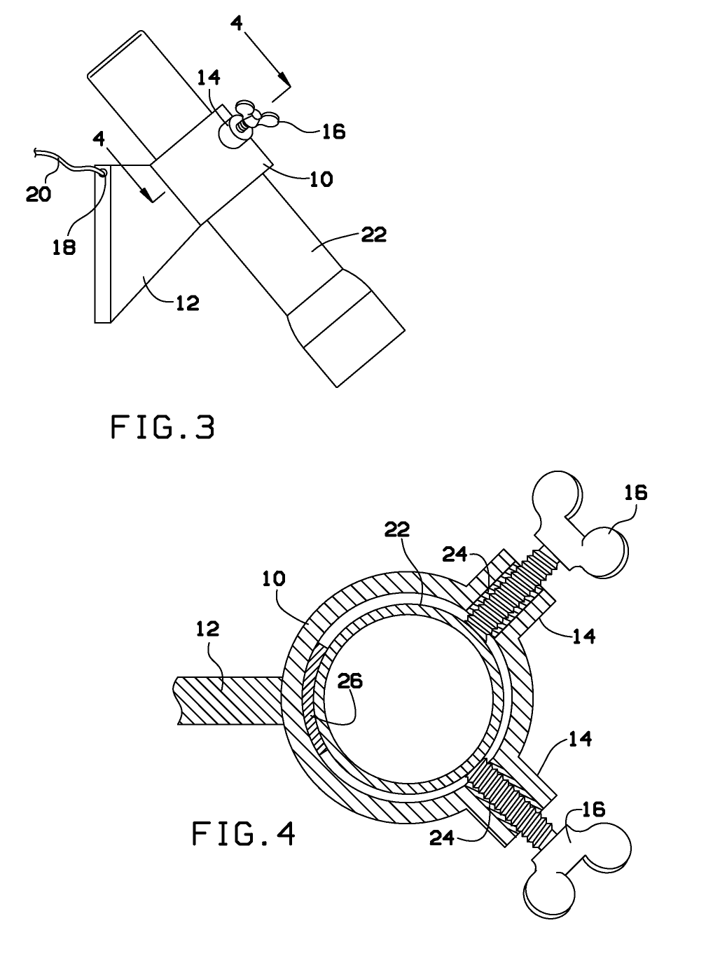

Referring now to FIGS. 1 through 4, a flashlight holder can include a holding cylinder 10 for receiving a flashlight 22 therein. A flexible composite material piece 26 can be disposed on a portion of the interior of the holding cylinder 10. The flexible composite material piece 26 can be a slip resistant material, such as rubber, to help hold the flashlight 22 inside the holding cylinder 10.

Threaded bosses 14 can be disposed through the holding cylinder 10. An adjustment mechanism, such as adjustment screws 16 can be threaded into threaded inserts 24 disposed in the threaded bosses 14 to extend inside the holding cylinder 10. Typically two threaded bosses 14 are provided, although one or more threaded bosses 14 can be used. Typically, the threaded bosses 14 are disposed such that, when tightened against the flashlight 22 (as shown in FIG. 4), the adjustment screws 16 can apply a pressure on the flashlight 22 that is directed to the flexible composite material piece 26, pressing the flashlight 22 against the flexible composite material piece 26 and holding the flashlight 22 in place within the holding cylinder 10.

The holding cylinder 10 can be disposed on a base 12. The base 12 includes a flat portion adapted to be disposed against the user as shown in FIG. 1. A longitudinal axis of the holding cylinder 10 can be angled away from the flat portion of the base 12 at an angle from about 30 to about 50 degrees, typically about 40 degrees. Such a configuration directs the light projection from the flashlight 22 in front of the user.

One or more lanyard holes 18, typically one lanyard hole 18 on each side of the base 12, can be disposed through the base 12. An adjustable lanyard 20 can be threaded through the lanyard holes 18. The lanyard 20 is operable to be placed over a user's head to permit the flashlight holder to be worn around the user's neck.

The flashlight holder of the present invention can include a holding cylinder 10 capable of holding a conventional cylindrical flashlight 22. The user is not required to use an integrated light or a specially designed flashlight with the flashlight holder of the present invention.

While the above described the holding cylinder 10 as being cylindrical, the holding cylinder 10 can be designed with various cross-sections and in various sizes to accommodate various sizes and shapes of flashlights.

The flashlight holder of the present invention can be used in various applications where light is needed and both hands of the user may be required for other purposes other than holding a flashlight. For example, hunters can use the flashlight holder in the early mornings before dawn in the dark when there is no light for visibility and much physical work and preparation is needed to be accomplished in darkness.

It should be understood, of course, that the foregoing relates to exemplary embodiments of the invention and that modifications may be made without departing from the spirit and scope of the invention as set forth in the following claims.

What is claimed is:

1. A flashlight holder comprising:
a holding cylinder;
a base supporting the holding cylinder, wherein the holding cylinder is angled at an angle from about 30 to about 50 degrees from the base;
an adjustable lanyard extending from the base; and
a securing mechanism for securing a flashlight inside the holding cylinder.

2. The flashlight holder of claim 1, further comprising:
one or more threaded bosses extending into an interior of the holding cylinder, wherein
the securing mechanism threads into the one or more threaded bosses to secure the flashlight inside the holding cylinder.

3. The flashlight holder of claim 2, further comprising threaded inserts disposed in the one or more threaded bosses.

4. The flashlight holder of claim 2, further comprising a flexible composite material piece disposed on a portion of an inside surface of the holding cylinder.

5. The flashlight holder of claim 4, wherein the flexible composite material piece is disposed opposite the securing mechanism.

6. The flashlight holder of claim 2, wherein the securing mechanism is one or more adjustment screws.

7. The flashlight holder of claim 1, wherein the base includes one or more lanyard holes for threading the lanyard therethrough.

8. A flashlight holder comprising:
a holding cylinder;
a base supporting the holding cylinder, wherein the holding cylinder is angled at an angle from about 30 to about 50 degrees from the base;
an adjustable lanyard extending from the base;
one or more threaded bosses extending into an interior of the holding cylinder;
threaded inserts disposed in the one or more threaded bosses;
a securing mechanism for securing a flashlight inside the holding cylinder; and
a flexible composite material piece disposed on a portion of an inside surface of the holding cylinder, wherein
the securing mechanism threads into the one or more threaded bosses to secure the flashlight inside the holding cylinder.

9. The flashlight holder of claim 8, wherein the flexible composite material piece is disposed opposite the securing mechanism.

10. The flashlight holder of claim 8, wherein the securing mechanism is one or more adjustment screws.

11. The flashlight holder of claim 8, wherein the base includes one or more lanyard holes for threading the lanyard therethrough.
